(19) United States
(12) Patent Application Publication
(10) Pub. No.: US 2016/0160088 A1
(43) Pub. Date: Jun. 9, 2016

(54) ADHESIVE TAPE STRUCTURE

(71) Applicant: Kuo-Chun Yen, (US)

(72) Inventor: Kuo-Chun Yen, New Taipei City (TW)

(21) Appl. No.: 14/564,221

(22) Filed: Dec. 9, 2014

(51) Int. Cl. C09J 7/02

(52) U.S. Cl. CPC C09J 7/026; C09J 7/025; C09J 2201/122

(57) ABSTRACT

The present disclosure illustrates an adhesive tape structure including a tape body and a plurality of tearing portions. The tape body includes a first surface and a second surface, and is provided with an indicating part on the first surface thereof, and an adhesive layer coated on the second surface thereof, The plurality of tearing portions are arranged on the tape body. Therefore, the adhesive tape structure can directly show the length of the portion being drawn out for measurement, and user can tear off the tape body via the tearing portion by finger, so that the effects of convenient usage, direct display and measurement can be achieved.

### BACKGROUND OF THE INVENTION

1. Field of the Invention

The present disclosure relates to an adhesive tape, more particularly to an adhesive tape structure having graduation indication and capable of being torn off directly and conveniently.

2. Description of the Related Art

An existing adhesive tape usually includes an adhesive surface for adhering on an object and a release surface opposite to the adhesive tape. The adhesive tape layer is overlappingly rolled in a circular shape, and the adhesive tape is adhered on the release surface. The existing adhesive tapes are mainly classified into a plastic adhesive tape and a paper adhesive tape, and are extensively used in daily life.

The conventional plastic adhesive tape is mostly applied to bind or seal object, While in use, the end of the adhesive tape at outer layer is first torn and separated from the adhesive tape adhered therewith, and after a required length of the adhesive tape is drawn, the user can cut off the required length of the adhesive tape by scissors or other tool. However, it is not convenient for the user to operate the scissors or blade during using the adhesive tape; moreover, the user is really puzzled and bothered to fix the adhesive tape manually and use the tool to cut out the adhesive tape at the same time while binding or sealing the object.

The most of the conventional paper adhesive tapes are used in engineering construction for temporarily binding or separating from the paint coatings after binding. When binding the paper adhesive tape, the user can measure a size of the goods by using a flexible rule. However, it is not easy to measure the size of the adhesive tape by the flexible rule, and the size of the adhesive tape measured by the flexible rule is hard to be precise. Therefore, when the user draw and cut off the adhesive tape, the obtained adhesive tape is usually too short or too long. If the obtained adhesive tape is too short, user must spend more time to cut off other adhesive tape again; if the obtained adhesive tape is too long, the usage of the obtained adhesive tape results in waste.

### SUMMARY OF THE INVENTION

The application provides an adhesive tape structure having graduation indication and capable of being directly torn off directly and conveniently.

The application provides an adhesive tape structure including a tape body and a plurality of tearing portions. The tape body has a first surface and a second surface opposite to the first surface. The tape body is provided with an indicating portion on the first surface, and an adhesive layer covered on the second surface opposite to the first surface. The tearing portions are disposed on the tape body in interval, and the each of the tearing portions is parallel with a short edge of the tape body. Therefore, the adhesive tape structure can directly show the length of the portion being drawn out for measurement, and user can tear off the tape body via the tearing portion by finger, so that the effects of convenient usage, direct display and measurement can be achieved.

In order to make the aforementioned and other features and advantages of the invention more comprehensible, several embodiments accompanied with figures are described in detail below.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a perspective view of a first preferred embodiment of the present disclosure;

FIG. 2 is a partial schematic view of the first preferred embodiment of the present disclosure;

FIG. 3 is a section view of the first preferred embodiment of the present disclosure;

FIG. 4 is a perspective view of a second preferred embodiment of the present disclosure;

FIG. 5 is a partial schematic view of the second preferred embodiment of the present disclosure;

FIG. 6 is a section view of the second preferred embodiment of the present disclosure.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

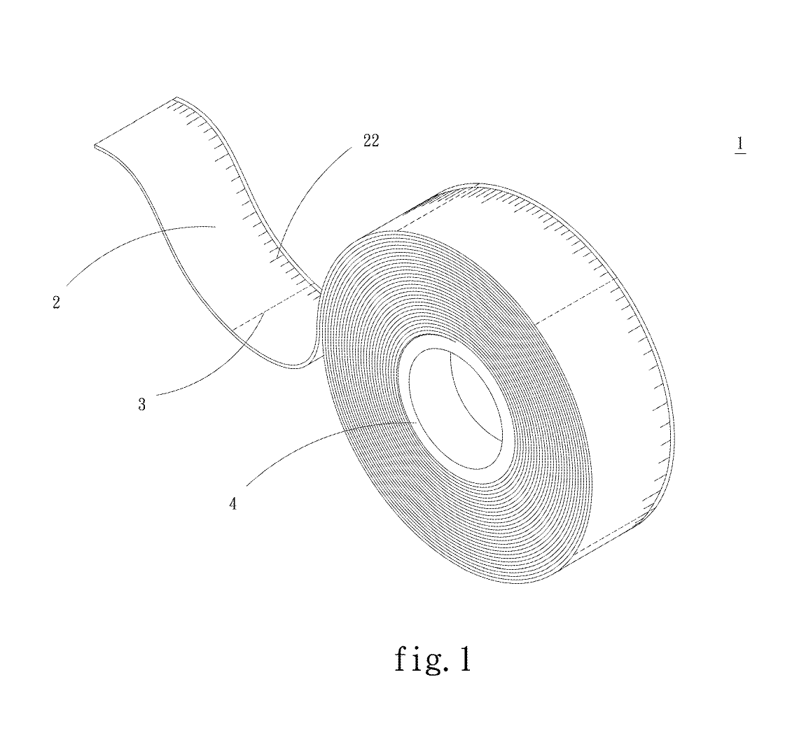

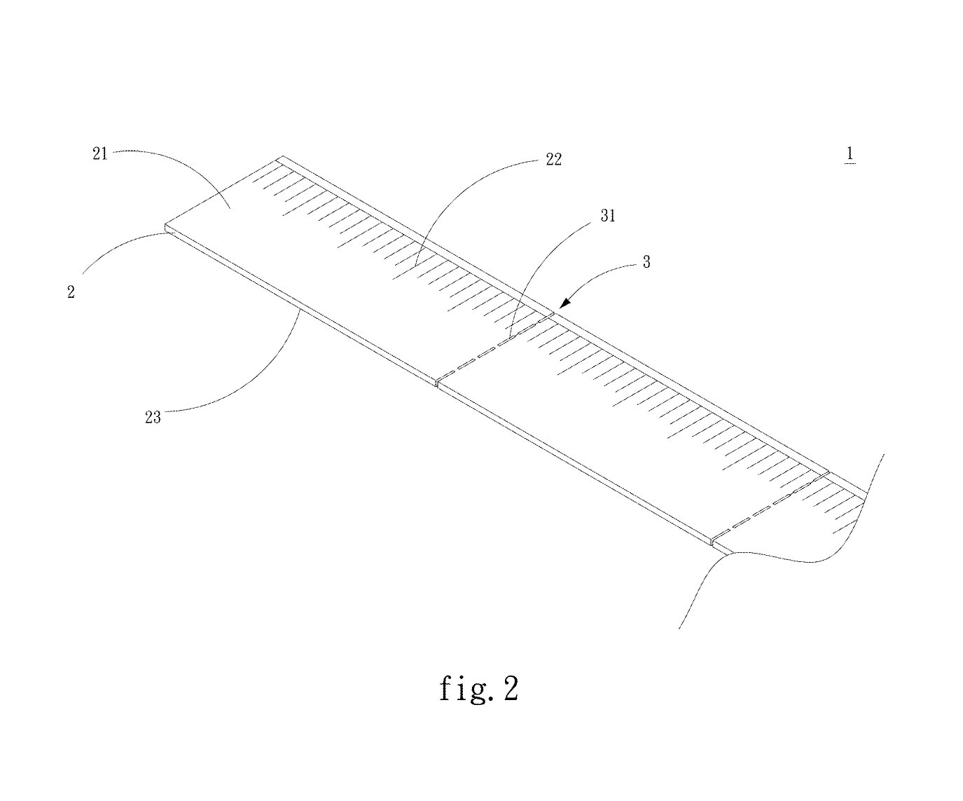

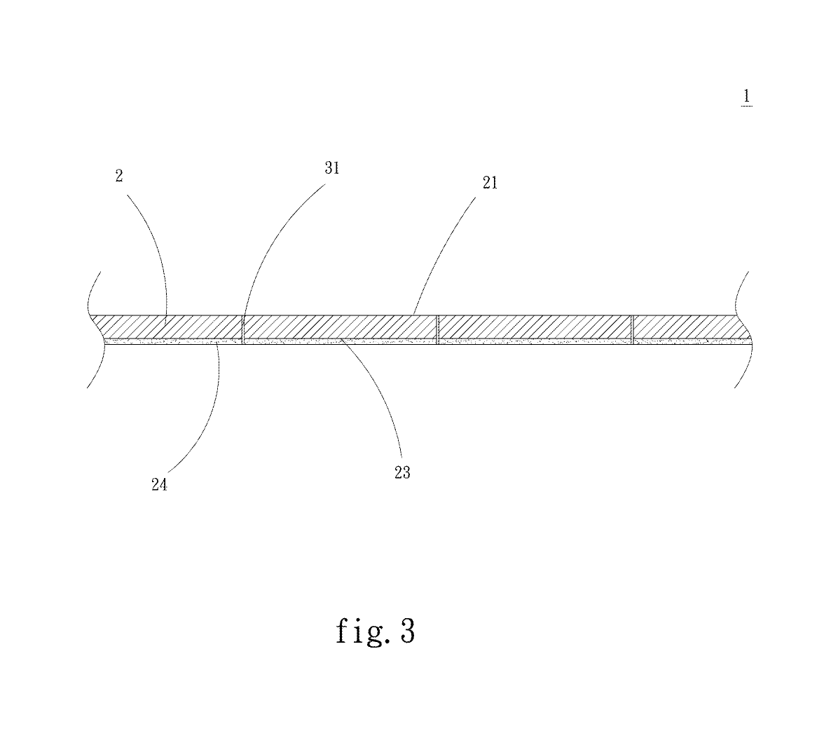

Please refer to FIG. 1, FIG. 2 and FIG. 3 which are perspective view, schematic view and cross-sectional view of a first preferred embodiment of an adhesive tape structure of the present disclosure, respectively. As shown in FIGs, the adhesive tape structure 1 includes a tape body 2, a plurality of tearing portions 3 and a cylinder 4.

The tape body 2 has a first surface 21 and a second surface 23 opposite to the first surface 21. The tape body 2 is provided with an indicating portion 22 on the first surface 21. In this embodiment, the indicating portion 22 is printed on the first surface 21 for indicating size, but the present disclosure is not limited thereto. If the tape body 2 is made of transparent plastic material, the indicating portion 22 can be printed on the second surface 23 and also shown on the first surface 21 via the transparent plastic material. In this embodiment, the indicating portion 22 is implemented on the first surface 21 by printing. Moreover, the tape body 2 is provided with an adhesive layer 24 completely coated on the second surface 23 thereof.

Moreover, the tearing portions 3 are disposed on the tape body 2, and each is formed in arrangement of at least one continuous or discontinuous hole 31. The hole 31 can be passed through the tape body 2 or not passed through the tape body 2. In this embodiment, the holes 31 is implemented by continuous arrangement and being passed through the adhesive layer 24 of the tape body 2, but the present disclosure is not limited thereto, the hole 31 can also be in discontinuous arrangement and not passed through the adhesive layer 24 or the tape body 2. Each of the tearing portions 3 is parallel with the short edge of the tape body 2, and two ends of the tearing portion 3 are disposed at long edge of two sides of the tape body 2 respectively, and the tearing portions 3 are arranged on the tape body 2 in interval. The tape body 2 is adhered on the cylinder 4 by the adhesive layer 24 of the second surface 23, and rolled on the cylinder 4. The adhesive layer 24 is coated on the first surface 21 corresponding thereto while being rolled, so as to complete the adhesive tape structure 1 after rolling. Therefore, the adhesive tape structure 1 can directly show the length of the portion drawn out for measurement, and user can tear off the tape body 2 via the tearing portion 3 by finger, so that the effects of convenient usage, direct display and measurement can be achieved.

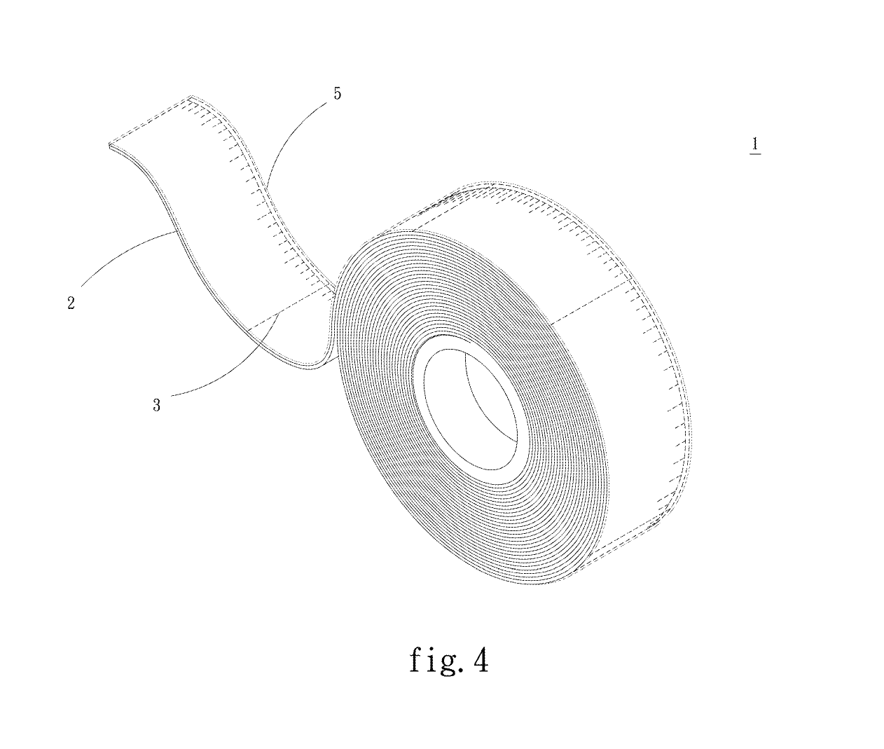

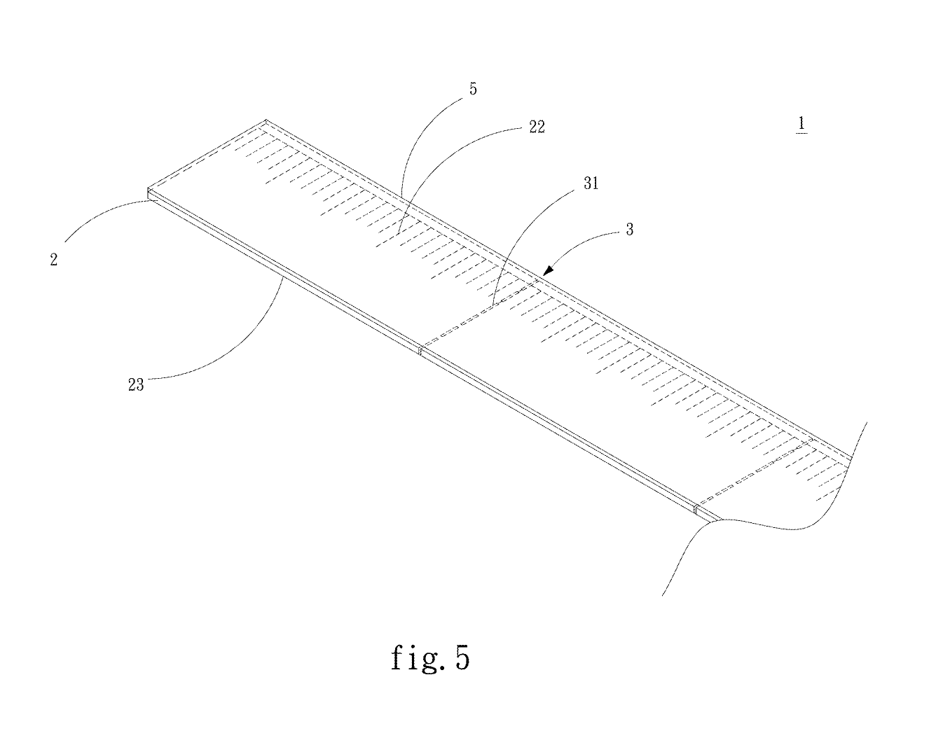

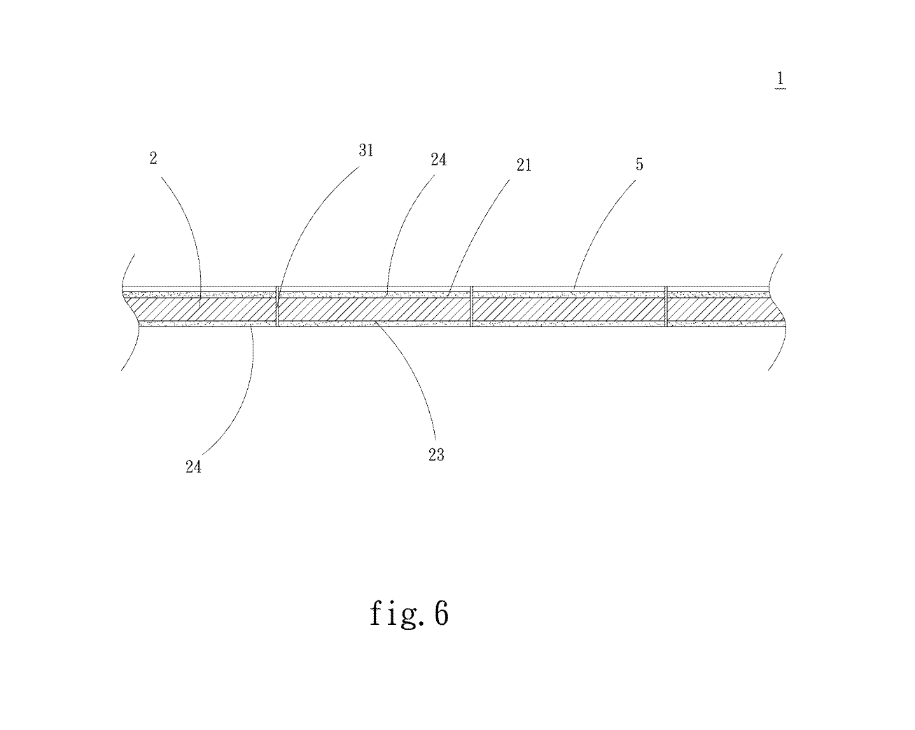

Please refer to FIG. 4, FIG. 5 and FIG. 6 which are perspective view, schematic view and cross-sectional view of a second preferred embodiment of the adhesive tape structure of the present disclosure, respectively. As shown in FIGs, some structures of this embodiment are the same as that of the first embodiment, so their detailed descriptions are omitted. The difference between the second embodiment and the first embodiment is that the adhesive layer 24 is also coated on the first surface 21, and a release liner 5 is disposed on a side of the adhesive layer 24 on the first surface 21, and the side opposite to the tape body 2, whereby the tape body 2 of the adhesive tape structure 1 becomes a double-sided tape structure. A release liner 5 is utilized to prevent the adhesive layer 24 of the first surface 21 from sticking to themselves. The release liner 5 is normally a silicone coated paper or filmic material. When the adhesive tape structure 1 is rolled on the cylinder 4, the adhesive layer 24 of the second surface 23 is attached on the release liner 5 and the holes 31 of the tearing portion 3 are passed through the tape body 2 and the release liner 5 are the same time, so as to facilitate to use the adhesive tape structure 1 to directly show the length of the portion being drawn out directly for measurement, and the user can directly tear off the tape body 2 via the tearing portion 3 by user's finger. Therefore, the effects of convenient usage, direct display and measurement can be achieved.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An adhesive tape structure, comprising:
a tape body, comprising a first surface and a second surface, the tape body provided with an indicating part on the first surface thereof, and an adhesive layer coated on the second surface thereof; and
a plurality of tearing portions, disposed on the tape body, and each of the plurality of tearing portions parallel with a short edge of the tape body.

2. The adhesive tape structure according to claim 1, wherein two ends of each of the plurality of tearing portions are disposed at long edges of the tape body at two sides.

3. The adhesive tape structure according to claim 1, further comprising a cylinder, and wherein the tape body is rolled on the cylinder.

4. The adhesive tape structure according to claim 1, wherein the adhesive layer is further coated on the first surface.

5. The adhesive tape structure according to claim 4, further comprising a release liner disposed on a side of the adhesive layer on the first surface, and the side opposite to the tape body.

6. The adhesive tape structure according to claim 1, wherein each of the plurality of the tearing portions is formed in arrangement of at least one continuous or discontinuous hole.

7. The adhesive tape structure according to claim 6, wherein the hole is passed through the tape body or not passed through the tape body.

8. The adhesive tape structure according to claim 1, wherein the plurality of tearing portions are arranged on the tape body in interval.
